(19) United States
(12) Patent Application Publication
(10) Pub. No.: US 2013/0155002 A1
(43) Pub. Date: Jun. 20, 2013

(54) MUTUAL CAPACITANCE TOUCH PANEL

(71) Applicant: Kai-Ti YANG, Taoyuan (TW)

(72) Inventor: Kai-Ti YANG, Taoyuan (TW)

(21) Appl. No.: 13/332,351

(22) Filed: Dec. 20, 2011

(51) Int. Cl. G06F 3/044

(52) U.S. Cl. 345/174

(57) ABSTRACT

A mutual capacitance touch panel comprises a conductive layer installed between a substrate and a surface layer; the conductive layer installed with a touch sensing circuit; the touch sensing circuit being formed by a plurality of sensing arrays; each sensing array including a driving electrode and a plurality of sensing electrodes; the driving electrode being installed on the substrate and extending along a first direction; the driving electrode having a main conductor; a lateral side of the main conductor being extended with a plurality of sub-conductors which are parallel extended along a second direction; two adjacent sub-conductors and the main conductor defining an insulating space of the driving electrode; the sensing electrode having a similar configuration like the driving electrode. The sub-conductors of the driving electrode and the sub-conductors of the sensing electrode are alternatively arranged.

### FIELD OF THE INVENTION

The present invention related to capacitive touch panels, and in particular to a mutual capacitance touch panel.

### BACKGROUND OF THE INVENTION

Transparency touch panel is used to cover the display screen of an electronic device for interactive inputting so as to improve the interaction between the user and the device in an efficiency way. A touch panel is made of sensors, a control panel and other software. Based on the operation principle and the structure, the touch panels are classified as resistive, capacitive, infrared and supersonic touch panels, etc. However currently, capacitive touch panels with multiple sensing points are the main trend in the improvement of the touching sensing effect, cracking-proof and wearing-proof because it uses the function of single point sensing. Generally, a capacitive touch panel has two transparent conductive films which are insulated from one another, such as made of ITO. Each film has a desire electrode pattern to form as a plurality of X traces and Y traces. The undesired portions on the film are etched out to form with the traces and these traces are isolated with a predetermined width. The touch of a finger on the capacitive touch panel will cause the variation of the capacitance so as to determine the touch position. However since the X traces and the Y traces are installed on different planes. In touch operation, it is possible the alignment of the X trace and Y trace is not precise so as to reduce the sensitivity of capacitance and the precision. Furthermore, the different planes of the X trace layer and Y trace layer will widen the thickness of the panel. Not only the transparency is reduced, but also since a plane has the X trace layer (or Y trace layer) and other portion is not occupied by the trance so that the transparency is not uniform. As a result, the images on the screen will deform, vague or distort. Moreover, shadow effect and electromagnetic interference will affect the quality of the image on the screen.

In one prior art about the touch display device and touch sensing device, as illustrated in FIG. 1, in that a touch sensing elements installed on display screen is disclosed. It contains a plurality of sensing electrodes and a plurality of driving electrodes. These electrodes are arranged as a grid. The sensing electrodes and the driving electrodes are alternatively arranged so as to form as a rectangular array, causing that the sensing electrodes and the driving electrodes are arranged on the same conductive thin film. However for the driving electrodes on the same directions are connected by bridging circuits. Other than the steps in the process are increased, one more insulating layer and one more bridging circuit layer are needed.

### SUMMARY OF THE INVENTION

The object of the present invention is to provide a mutual capacitance touch panel, in that the X traces, Y traces, signal transmission lines and other touch sensing circuits are arranged on the same conductive layer so that all the electrodes are positioned precisely, as a result, the sensitivity and precision in touch operation are promoted. Furthermore, the touch sensing circuit can be directly arranged on a thin film so as to further reduce the thickness of the touch panel, causing the transparency and the uniformity of the touch panel are also enhanced. Furthermore, the viewing effect is improved without extra metal trace. The manufacturing process is simplified and the cost is reduced.

To achieve above object, the present invention provides a mutual capacitance touch panel comprises a conductive layer (200) installed between a substrate (100) and a surface layer (300); the conductive layer installed with a touch sensing circuit; the touch sensing circuit being formed by a plurality of sensing arrays (250); each sensing array (250) including a driving electrode (10) and a plurality of sensing electrodes (20); the driving electrode being installed on the substrate 100 and extending along a first direction; the driving electrode having a main conductor (10a); a lateral side of the main conductor being extended with a plurality of sub-conductors (10b) which are parallel extended along a second direction; two adjacent sub-conductors (10b) and the main conductor (10a) defining an insulating space (10c) of the driving electrode; the sensing electrode (20) being installed on the substrate (100) and extends along the first direction; the sensing electrode being parallel to the driving electrode (10); the sensing electrode having a main conductor (20a); a lateral side of the main conductor (20a) of the sensing electrode (20) being extended with a plurality of sub-conductors (20b) which are parallel extended along a second direction; two adjacent sub-conductors (20b) of the sensing electrode (20) and the main conductor (20a) of the sensing electrode (20) defining an insulating space (20c) of the sensing electrode; the sub-conductors (20b) of the sensing electrode (20) being installed in the insulating spaces (10c) of the driving electrode (10); and the sub-conductors (10b) of the driving electrode (10) being installed in the insulating spaces (20c) of the sensing electrode (20); that is to say, the sub-conductors (10b) of the driving electrode and the sub-conductors (20b) of the sensing electrode (20) are alternatively arranged.

### BRIEF DESCRIPTION OF THE DRAWINGS

FIG. 1 is a lateral cross sectional view of the present invention.

FIG. 2 shows the layout of the touch sensing circuit of the present invention.

FIG. 3 is an enlarged view of the part D in FIG. 2.

FIG. 4 is a schematic view showing the layout of the driving electrode in part D of FIG. 2.

FIG. 5 is a schematic view showing the layout of the sensing electrodes in part D of FIG. 2.

FIG. 6 is a schematic view showing the layout of another sensing electrode in another embodiment of the present invention.

FIG. 7 is a schematic view showing the layout of a further sensing electrode in a further embodiment of the present invention.

FIG. 8 is a schematic view showing the layout of a yet sensing electrode in a yet embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

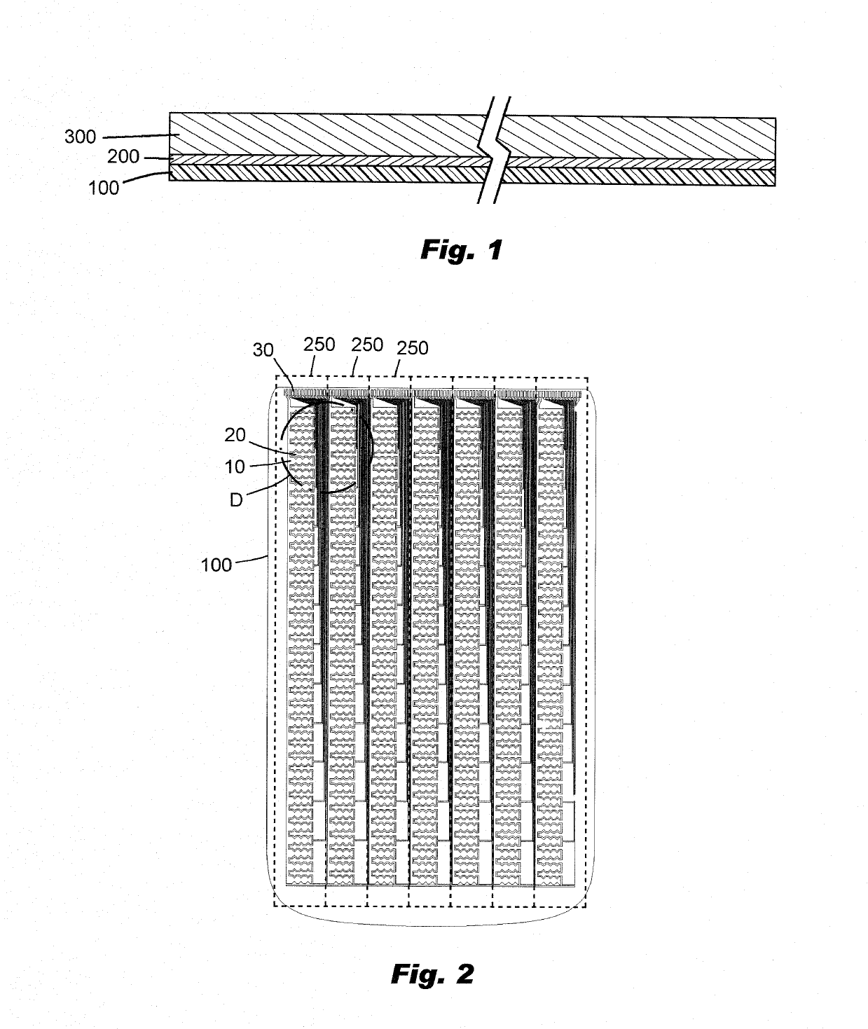

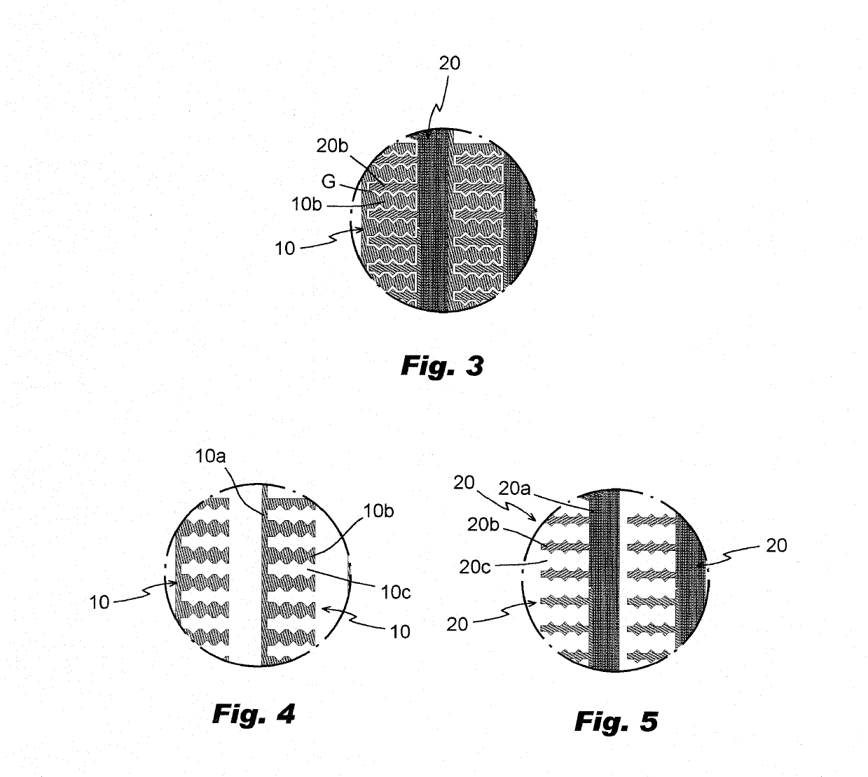

Referring to FIGS. 1 to 5, the structure of the present invention includes a conductive layer 200 installed between a substrate 100 and a surface layer 300. The conductive layer 200 is installed with a touch sensing circuit. The touch sensing circuit is formed by a plurality of sensing arrays 250. Each sensing array 250 includes a driving electrode 10 and a plurality of sensing electrodes 20. The driving electrode 10 is installed on the substrate 100 and extends along a Y axis. The driving electrode 10 has a main conductor 10a. A lateral side of the main conductor 10a is extended with a plurality of sub-conductors 10b which are parallel extended along an X axis. Two adjacent sub-conductors 10b and the main conductor 10a defines an insulating space 10c (referring to FIG. 4). The sensing electrode 20 is installed on the substrate 100 and extends along the Y axis. The sensing electrode 20 is parallel to the driving electrode 10. The sensing electrode 20 has a main conductor 20a. A lateral side of the main conductor 20a of the sensing electrode 20 is extended with a plurality of sub-conductors 20b which are parallel extended along an X axis. Two adjacent sub-conductors 20b of the sensing electrode 20 and the main conductor 20a of the sensing electrode 20 define an insulating space 20c (referring to FIG. 5). The sub-conductors 20b of the sensing electrode 20 are installed in the insulating spaces 10c of the driving electrode 10; and the sub-conductors 10b of the driving electrode 10 are installed in the insulating spaces 20c of the sensing electrode 20. That is to say, the sub-conductors 10b of the driving electrode 10 and the sub-conductors 20b of the sensing electrode 20 are alternatively arranged.

Referring to FIG. 3, the gap between the sub-conductor 10b of the driving electrode 10 and the peripheral sensing electrode 20 is about 20 μm˜80 μm, preferably, about 30 μm˜50 μm. Similarly, the gap between the sub-conductor 20b of the sensing electrode 20 and the peripheral driving electrode 10 is about 20 μm˜80 μm, preferably, about 30 μm˜50 μm. Thus, it can provide preferred electric insulation and preferred transparency.

The main conductors 10a of the driving electrode 10 and the main conductors 20a of the sensing electrode 20 are used for signal input and output. The main conductors 10a and the main conductors 20a are connected to the joints 30 at an edge of the panel and then the joints are connected to a sensing signal processing circuit (not shown) for deriving the sensing positions. A driving electrode 10 can be matched with at least one sensing electrode 20 so as to form as a sensing array 250. A plurality of sensing arrays 250 are formed as a touch sensing circuit (referring to FIG. 2).

In above mentioned embodiment, the sub-conductors 10b of the driving electrode 10 and the sub-conductors 20b of the sensing electrode 20 are arranged parallel along the Y axis. However the present invention is not confined to this scope. Practically, they can be arranged along the X axis or any other direction. In above embodiment, the main conductor 20a is vertical to the sub-conductors 20b and the main conductors 10a is vertical to the sub-conductors 10b. However the intersecting angles between the main conductors and the sub-conductors are not confined to the orthogonal arrangement, other selection is permissible in the present invention.

In above structure, the substrate 100, conductive layer 200 and the surface layer 300 are made of high transparent material so as to form as a transparent panel. The materials of the substrate 100 and the surface layer 300 are transparent insulated thin film, which may be glass, Polycarbonate (PC), Polythylene terephthalate (PET), polymethylmethacrylate (PMMA), or Cyclic Olefin Copolymer (COC). Preferably, the material of the substrate 100 is selected from flexible thin film of Polycarbonate (PC) or Polythylene terephthalate (PET). The conductive layer 200 for forming the touch sensing circuit is formed by the material selected from transparent thin film of Indium Tin Oxide (ITO), Indium Zinc Oxide (IZO), Aluminum Zinc Oxide (AZO) or PEDOT etc. Preferably, the conductive layer 200 is directly installed on the substrate 100. The desired circuit is formed by etching or laser engraving.

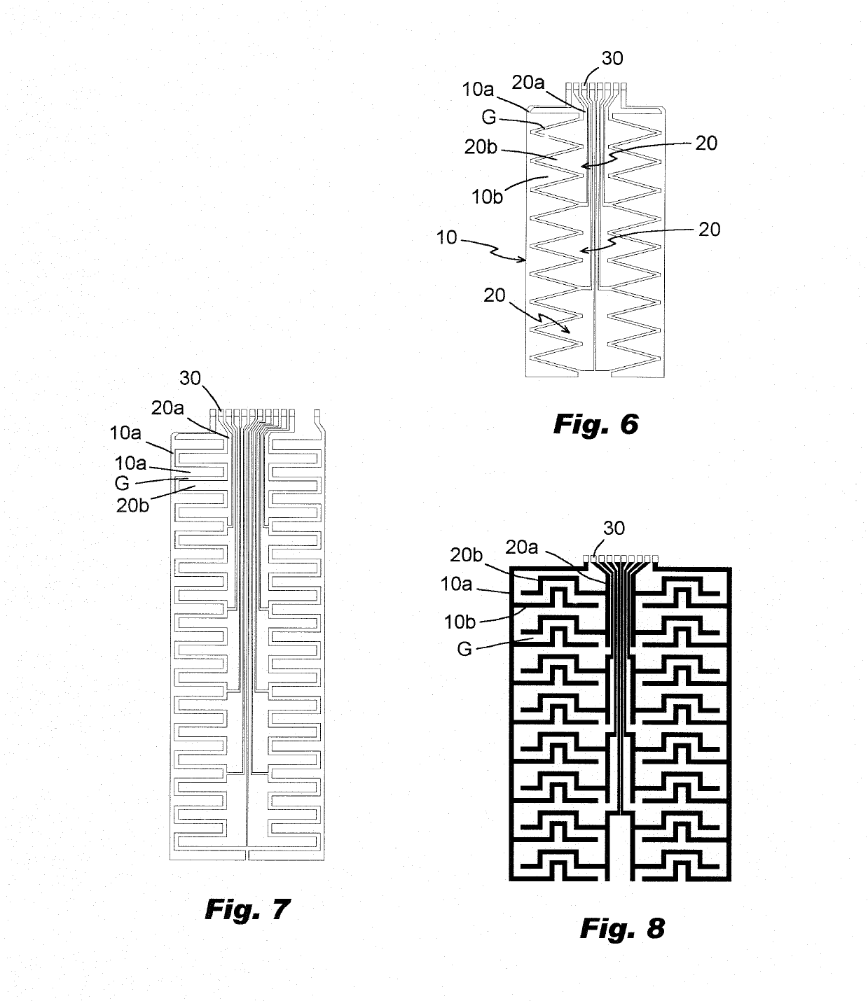

It is known that the larger the capacitance between the driving electrode 10 and the sensing electrode, the larger the variation of the coupling sensing signals in touching operation. Thus the sensitivity in touch operation is promoted. In this embodiment, the driving electrode 10 and the sensing electrode 20 has a configuration like a comb and are arranged alternatively so that that the areas of the electrodes are increased to increase the capacitance therebetween. As a result, the touch sensitivity is enhanced. In fact, the configuration of the sub-conductors of the electrodes also affects the mutual capacitance thereof. In above embodiment, the sub-conductors 10b, and 20b have shapes including a rectangular strip with a plurality of triangular protrusions. In FIG. 6, the sub-conductors 10b, and 20b have triangular shapes. In FIG. 7, the sub-conductors 10b, and 20b have rectangular shapes. However shapes of the sub-conductors 10b, and 20b may be rectangular shapes, triangles, polygonal shapes, or round shapes or the combination of above shapes. The shapes of sub-conductors 10b, and 20b may be a strip, for example, in FIG. 8, it is illustrated that the sub-conductors 10b, 20b have shape like a folded strip. In other embodiment, the sub-conductors 10b, 20b have shape like a continuous straight line, a folded line or a curved line or the combination of above line shapes. When the shape of sub-conductors of the driving electrode 10 is different from that of the sub-conductor of the sensing electrode 20, the shapes of the insulation spaces are also varied, so that the sub-conductors must be designed to match the peripheral insulation space. The shapes, numbers and arrangements of the sub-conductors of the driving electrode and the sub-conductors of the sensing electrode are adjustable based on necessity in design of the product. They are not confined to above mentioned embodiments.

It should be noted, that the widths of the driving electrode 10a and the sensing electrodes 20a should be as slender as possible so as to reduce the gap between two parallel arranged sensing array and thus reduce the area which can not be sensed so as to promote the sensitivity and the precision of touch operation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mutual capacitance touch panel, comprising:
a conductive layer (200) installed between a substrate (100) and a surface layer (300);
the conductive layer installed with a touch sensing circuit; the touch sensing circuit being formed by a plurality of sensing arrays (250); each sensing array (250) including a driving electrode (10) and a plurality of sensing electrodes (20);
the driving electrode being installed on the substrate (100) and extending along a first direction; the driving electrode having a main conductor (10a); a lateral side of the main conductor being extended with a plurality of sub-conductors (10b) which are parallel extended along a second direction; two adjacent sub-conductors (10b) and the main conductor (10a) defining an insulating space (10c) of the driving electrode;
the sensing electrode (20) being installed on the substrate (100) and extending along the first direction; the sensing electrode being parallel to the driving electrode (10); the sensing electrode having a main conductor (20a); a lateral side of the main conductor (20a) of the sensing electrode (20) being extended with a plurality of sub-conductors (20b) which are parallel extended along a second direction; two adjacent sub-conductors (20b) of the sensing electrode (20) and the main conductor (20a) of the sensing electrode (20) defining an insulating space (20c) of the sensing electrode; the sub-conductors (20b) of the sensing electrode (20) being installed in the insulating spaces (10c) of the driving electrode (10); and the sub-conductors (10b) of the driving electrode (10) being installed in the insulating spaces (20c) of the sensing electrode (20); that is to say, the sub-conductors (10b) of the driving electrode and the sub-conductors (20b) of the sensing electrode (20) are alternatively arranged.

2. The mutual capacitance touch panel as claimed in claim 1, wherein a shape of the sub-conductor (10b) of the driving electrode is compensated to a shape of the insulating space (20c) of the sensing electrode.

3. The mutual capacitance touch panel as claimed in claim 1, wherein a shape of the sub-conductor (20b) of the sensing electrode is compensated to a shape of the insulating space (10c) of the driving electrode 10.

4. The mutual capacitance touch panel as claimed in claim 1, wherein a gap is formed between the sub-conductor (10b) of the driving electrode (10) and a peripheral sensing electrode (20); and another gap is formed between the sub-conductor (20b) of the sensing electrode (20) and a peripheral driving electrode (10).

5. The mutual capacitance touch panel as claimed in claim 4, wherein the gaps are about 20 μm˜80 μm.

6. The mutual capacitance touch panel as claimed in claim 1, wherein shapes of the sub-conductors of the driving electrode and the sub-conductors of sensing electrode are selected from rectangular shapes, triangles, polygonal shapes, or round shapes or the combination of above shapes.

7. The mutual capacitance touch panel as claimed in claim 1, wherein the sub-conductors of the driving electrode and the sensing electrode have shape like a continuous straight line, a folded line or a curved line or the combination of above line shapes.

8. The mutual capacitance touch panel as claimed in claim 1, the surface layer is a high transparency insulating thin film for clamping the conductive layer.
